(19) United States
(12) Patent Application Publication
(10) Pub. No.: US 2008/0068135 A1
(43) Pub. Date: Mar. 20, 2008

(54) RFID Tag System and Data Stream Thereof

(75) Inventors: Chen Pang Kung, Taoyuan County (TW); Zing Way Pei, Taichung City (TW); Hung Chun Chen, Hsinchu City (TW)

Correspondence Address: WPAT, PC;INTELLECTUAL PROPERTY ATTORNEYS, 2030 MAIN STREET, SUITE 1300, IRVINE, CA, 92614, US

(73) Assignee: INDUSTRIAL TECHNOLOGY RESEARCH INSTITUTE, Hsinchu County (TW)

(21) Appl. No.: 11/674,151

(22) Filed: Feb. 13, 2007

(30) Foreign Application Priority Data
Sep. 1, 2006 (TW) 095132295

(51) Int. Cl. H04Q 5/22

(52) U.S. Cl. 340/10.4; 340/10.1; 340/572.1; 340/10.42

(57) ABSTRACT

An RFID tag system comprises at least one RFID tag and a reader. The RFID tag outputs a data stream including a head with a plurality of bits set to a sequence of certain levels and a body succeeding the head. The reader can detect the coding frequency of the data stream outputted from the RFID tag according to the known levels in the sequence, and then, read the body data based on the detected frequency.

### BACKGROUND OF THE INVENTION

1.Field of the Invention

The present invention relates to an RFID tag system and a data stream thereof, and more particularly, to an RFID tag system with high identifiability that transfers data via different frequency bands and a data stream thereof.

2. Description of the Related Art

As the RFID system becomes prevalent, the application of the bar code has gradually been replaced by the RFID system. The largest company in the American retail industry, Walmart required its first 100 suppliers to apply the RFID tag on all their packing cases and shelves before Jan. 1, 2005, and the German chain store Metro that uses RFID shelves opened in May, 2004. These large-scale international retail industries made the decisions to introduce the wireless RFID tag system because they believe that it can greatly enhance the product management efficiency.

However, during the early stages of the development of the RFID technology, the problems of a lack of common agreement on the frequency band used, the non-uniformity in the standard of the tag format, and the considerably high cost caused the proprietors who wanted to participate in the industry to hesitate. In order to solve these problems, Electronic Product Code Global (EPC global) cooperated with the American Massachusetts Institute of Technology Automatic Identification Laboratory (MIT Auto-Lab) to provide the supplier of the RFID products with detailed specifications and documents for all kinds of wireless frequency hardware and software interfaces, and to propose a new RFID tag protocol, that is, EPC communication protocol.

The EPC communication protocol is an extentable coding system, which is used for an adjustment design in coding to meet the requirements of different industries, so as to provide each object with a unique code. As known from the currently published EPC tag specification, there are two different tag capacities of 96 bits and 64 bits, and the code of 256 bits will also appear in the future, which is selected depending upon the requirements of the user, and the coding structure can be adjusted according to the capacity. The general identifier (GID) is used to divide the EPC code structure into four blocks, including a header, a general manager number, an object class, and a serial number.

Since the generally used EPC communication protocols are all quite complicated in defining the data stream, the tag itself must have the functions of a precise frequency output, and complicated frequency synchronization and time frame synchronization. Consequently, a stable unidirectional transmission or even a bidirectional transmission can be achieved between the reader and the tag. Once either the reader or the tag cannot meet the above requirements, the wireless communication path cannot be connected, so the identifiability is reduced.

In addition to the bottleneck for improving the identifiability, the cost of the standard silicon semiconductor process suitable for manufacturing the tag is excessively high, and the relative manufacturing speed is slower than the fast growth in demand. Therefore, a cost-effective and uncomplicated technology for manufacturing printed circuits is highly concened and discussed. The printed circuit manufacturing process has the advantages of low cost and simple process compared with the silicon semiconductor process, but also has the disadvantage that the electrical characteristics of the component vary significantly from the execution result of the manufacturing process. When the current wireless RFID tag data stream standard is combined with the printed circuit manufacturing process, it has the disadvantages of high level of integration, low yield, high cost, and high power consumption, which is extremely difficult to fulfill. Therefore, the advantages in the printed circuit manufacturing process cannot be brought into the current process for manufacturing tags.

Apparently, a new wireless RFID tag data stream is urgently needed in such an RFID market, which can be accomplished by a conventional transistor manufacturing process with a large variance in process that makes it difficult to highly integrate the integrated circuits (for example, OTFT, a-Si TFT, and LTPS TFT) or by a printed circuit manufacturing process. Both of these processes can achieve an RFID tag with high performance, low power consumption, and high identifiability.

### SUMMARY OF THE INVENTION

An objective of the present invention is to provide an RFID tag system and a data stream thereof, wherein a head with a plurality of bits of the data stream outputted by the RFID tag is set to a sequence of certain levels, and the frequency of the output signal of the RFID tag is identified by reading the sequence. Therefore, the present invention is suitable for RFID tags manufactured at a low cost and with a large variance. That is, even if the drift of the center frequency occurs due to the process variance, it will not affect the RFID tag system's ability to read data.

Another objective of the present invention is to provide an RFID tag system with high identifiability, which utilizes the difference between the frequency bands of signals outputted from the RFID tag to enhance the identifiability for reading the RFID tag, and the differences between the frequency bands are taken as different identification marks.

In order to achieve the above objects, the present invention discloses an RFID tag system and a data stream thereof, wherein the RFID tag system comprises at least an RFID tag and a reader. The RFID tag outputs a data stream including a head with a plurality of bits set to a sequence of certain levels and a body succeeding the head. The reader can detect the coding frequency of the data stream outputted from the RFID tag according to the known levels in the sequence, and then, read the body data based on the detected frequency.

Due to its capability to identify frequencies, the RFID tag system of the present invention is suitable for the RFID tag manufactured at a low cost and with a large variance. That is, the superior characteristic of frequency drift resulting from the process variance is utilized to achieve an RFID tag system with a frequency segmentation and a high identifiability.

### BRIEF DESCRIPTION OF THE DRAWINGS

The invention will be described according to the appended drawings in which:

FIG. 1 shows a packet structure of a data stream of an RFID tag system according to the present invention;

FIG. 2 is a coding waveform diagram of the data stream of the RFID tag system according to an embodiment of the present invention; and

FIG. 3 is a functional block diagram of the RFID tag system according to the present invention.

### DETAILED DESCRIPTION OF THE INVENTION

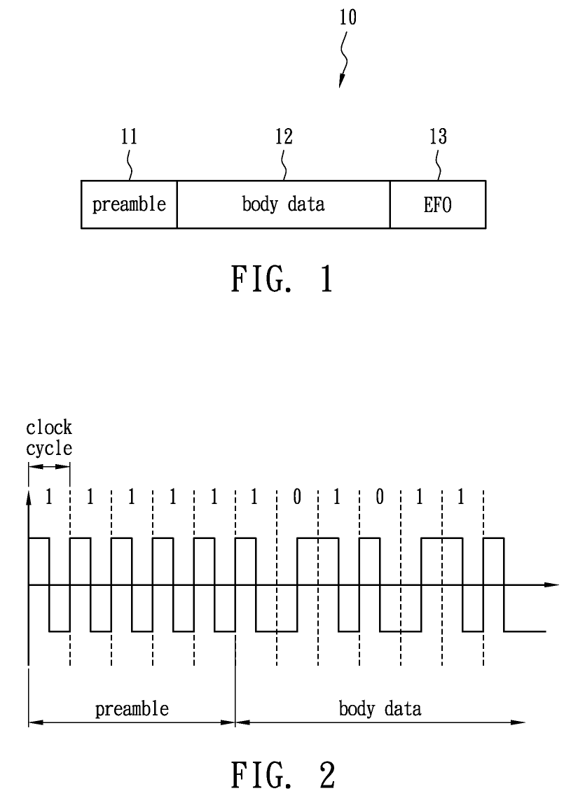

FIG. 1 shows a packet structure of a data stream of an RFID tag system according to the present invention. The data stream 10 includes a preamble 11, a body data 12, and an end of file (EOF) 13, wherein whether the EOF necessarily exists or not is determined according to the actual requirements of the system. The body data 12 includes the data for identifying the identity, such as an identity code, a series number, and an object class code. The preamble 11 is taken as a synchronous code, which is not only the head of the data stream 10, but also ensures that the signal transmission frequency of the data stream 10 is synchronized with the reading frequency.

FIG. 2 is a coding waveform diagram of the data stream of the RFID tag system according to the present invention. The first five bits of the data stream are designated as the preamble in the present embodiment, and the body data succeeds the preamble. As shown in FIG. 2, the preamble is set to a sequence of certain levels as 11111, and the body data is a binary value of 101011. When the reader (not shown) gets close to the RFID tag (not shown) having the data stream shown in FIG. 2, although it is known that the sequence stored in the preamble is 11111, the frequency or cycle of the clock is detected and confirmed only based on the known sequence 11111. Generally, the frequency of the clock is locked by the over-sampling method together with the digital signal processing (DSP), or, the frequency is confirmed by the phase lock loop (PLL). Only when the reader confirms the signal frequency or clock frequency of the data stream can make the content of the body data be correctly read.

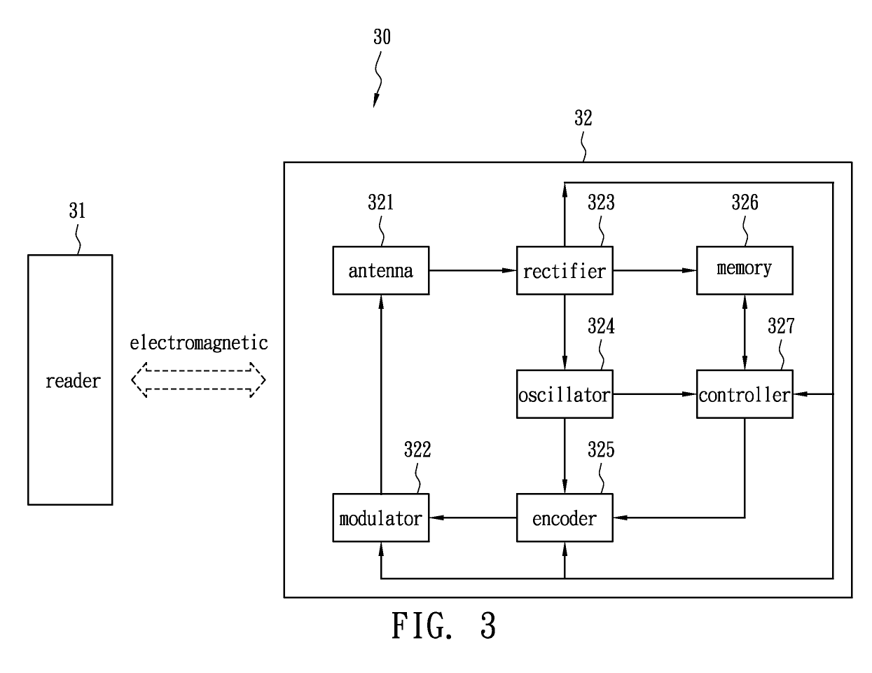

FIG. 3 is a functional block diagram of the RFID tag system according to the present invention. The RFID tag system 30 includes at least an RFID 32 and a reader 31, and the data is transmitted between the RFID tag 32 and the reader 31 by way of inductive coupling of the electromagnetic field. When an antenna 321 of the RFID tag 32 generates a current due to the change of the electromagnetic field, the current is converted via a rectifier 323 into a stable DC current for powering other circuits of the RFID tag 32.

The preamble and the body data in FIG. 2 are stored in the memory 326, and a controller 327 reads the data stored in the memory 326 according to the standard clock frequency produced by an oscillator 324 (for example, an annular oscillator), and then, the read data is sequentially transferred to an encoder 325 (for example, a Manchester encoder) for coding. The coding waveform shown in FIG. 2 is a waveform after the Manchester coding process, i.e., in a clock cycle, it is indicated as 1 when the voltage is converted from the positive potential into the negative potential, and otherwise, it is indicated as 0. The characteristic of this coding process lies in that the transferring end (the RFID tag 32) and the receiving end (reader 31) are synchronized when the data are transferred and received. However, the coding of the data stream of the present invention is not limited to the Manchester coding, and includes the pulse width modulation (PWM) coding, the non return to zero invert (NRZI) modulation or return to zero modulation. The coded data stream needs to be modulated by a modulator 322 before being sent to the reader 31 by the antenna 321, so that the digitally coded data stream becomes an analogous RF signal.

Due to the capability to identify frequencies, the RFID tag system 30 of the present invention is suitable for the RFID tag 32 manufactured at a low cost and with a large variance. That is, the superior characteristic of frequency drift resulting from the process variance is utilized to achieve an RFID tag system with a frequency segmentation and a high identifiability. Furthermore, cooperating with the encoder 325 and the memory 326 with a capacity of 64K, the number of the transistors on the chip of the RFID tag 32 is reduced to less than 200. Therefore, compared with the tag of EPC specification that requires tens of thousands of transistors, the RFID tag 32 of the present invention significantly reduces the circuit integration.

The above-described embodiments of the present invention are intended to be illustrative only. Numerous alternative embodiments may be devised by persons skilled in the art without departing from the scope of the following claims.

What is claimed is:

1. An RFID tag system, comprising:
at least an RFID tag for outputting a data stream, the data stream including a head with a plurality of bits set to a sequence of certain levels; and
a reader for detecting a coding frequency of the data stream outputted from the RFID tag according to the levels in the sequence.

2. The RFID tag system of claim 1, wherein the sequence is recorded in a preamble of the data stream.

3. The RFID tag system of claim 2, wherein the data stream further comprises a body data succeeding the preamble and acting as identification.

4. The RFID tag system of claim 3, wherein the data stream comprises at least one of an identity code, a series number and an object is class code.

5. The RFID tag system of claim 3, wherein the data stream further comprises an end of file (EOF) succeeding the body data.

6. The RFID tag system of claim 1, wherein the RFID tag further comprises a memory for storing the data stream.

7. The RFID tag system of claim 6, wherein the RFID tag comprises a controller for reading the data stream stored in the memory by referring to a standard clock.

8. The RFID tag system of claim 7, wherein the standard clock is generated by an oscillator.

9. The RFID tag system of claim 7, wherein the standard clock is generated by an annular oscillator.

10. The RFID tag system of claim 1, wherein the RFID tag comprises an encoder for conducting a binary coding on the data stream.

11. The RFID tag system of claim 10, wherein the encoder adopts a Manchester coding method to conduct a binary coding on the data stream.

12. A data stream used in an RFID tag system, comprising:
a preamble acting as a head of a data stream with a plurality of bits, the preamble set to a sequence of certain levels, wherein the sequence represents verification data of a coding frequency in the RFID tag system; and
a body data recording data for identification.

13. The data stream used in the RFID tag system of claim 12, further comprising an EOF succeeding the body data.
